(19) United States
(12) Patent Application Publication
(10) Pub. No.: US 2011/0187753 A1
(43) Pub. Date: Aug. 4, 2011

(54) INFORMATION PROCESSING APPARATUS AND METHOD FOR CONTROLLING CHARGING OF BATTERY

(76) Inventor: Hideki Watanabe, Ome-shi (JP)

(21) Appl. No.: 12/980,644

(22) Filed: Dec. 29, 2010

(30) Foreign Application Priority Data
Jan. 29, 2010 (JP) 2010-019543

(51) Int. Cl. G09G 5/10; H02J 7/00; H05B 41/36

(52) U.S. Cl. 345/690; 320/103; 315/307

(57) ABSTRACT

According to one embodiment, an information processing apparatus includes a first battery, a second battery whose capacity is smaller than capacity of the first battery, a solar battery, a charging circuit, an illumination sensor and a controller. The charging circuit is configured to charge the second battery with power output from the solar battery. The controller is configured to control the charging circuit in accordance with a sensing result of the illumination sensor.

### CROSS-REFERENCE TO RELATED APPLICATIONS

This application is based upon and claims the benefit of priority from Japanese Patent Application No. 2010-019543, filed Jan. 29, 2010; the entire contents of which are incorporated herein by reference.

### FIELD

Embodiments described herein relate generally to a power control technology favorable for a portable personal computer with a solar battery and the like.

### BACKGROUND

In recent years, personal computers such as a notebook computer and a desktop computer have widely been popularized as tools for sending/receiving email via the Internet, browsing information that is put on the Internet, and creating documents. Recently, one has become more interested in the protection of the environment, and various ideas about power saving as well as an increase in continuous running time have been proposed particularly for portable personal computers.

One of the ideas is to employ a solar battery as a power supply to make full use of solar energy. Various proposals for efficiently using power obtained by a solar battery have been so far offered (see Jpn. Pat. Appln. KOKAI Publication No. 9-200110).

Conventionally, the output voltage and output current of a solar battery are monitored in order to acquire power stably from the solar battery. In general, however, a solar battery has a radiation intensity characteristic (voltage-to-current characteristic) that a no-load voltage (open-circuit voltage) does not vary so greatly with radiation intensity and, if a fixed amount of current is acquired from the solar battery, an output voltage varies greatly with radiation intensity.

In order to monitor the output voltage and output current of a solar battery and acquire power stably from a solar battery on the basis of the output voltage and output current acquired by the monitoring, very complicated control is required, which becomes a barrier against a decrease in cost.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary external view of an information processing apparatus according to an embodiment.

FIG. 2 is an exemplary block diagram partly showing a system configuration of the information processing apparatus according to the embodiment.

FIG. 3 is an exemplary graph showing an example of radiation intensity characteristic (voltage-to-current characteristic) of a solar battery of the information processing apparatus according to the embodiment.

FIG. 4 is an exemplary flowchart showing a control procedure of the solar battery based on the sensing result of an illumination sensor of the information processing apparatus according to the embodiment.

### DETAILED DESCRIPTION

Various embodiments will be described hereinafter with reference to the accompanying drawings.

In general, according to one embodiment, an information processing apparatus includes a first battery, a second battery whose capacity is smaller than capacity of the first battery, a solar battery, a charging circuit, an illumination sensor and a controller. The charging circuit is configured to charge the second battery with power output from the solar battery. The controller is configured to control the charging circuit in accordance with a sensing result of the illumination sensor.

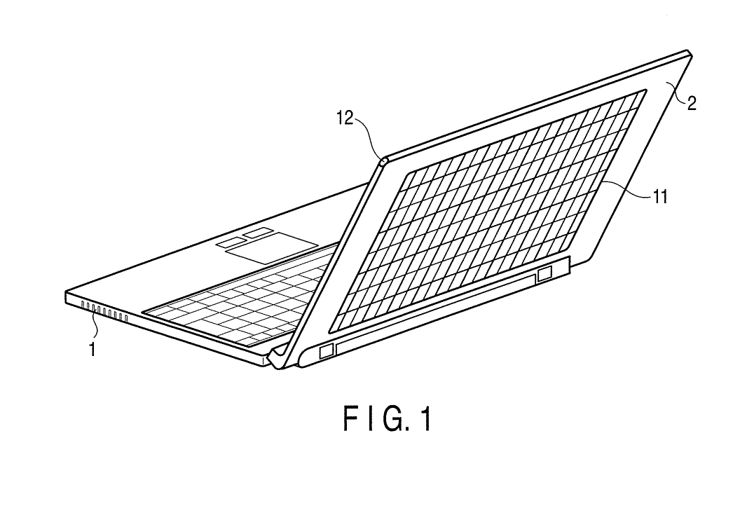

FIG. 1 is an exemplary external view of an information processing apparatus according to the embodiment. The information processing apparatus is achieved as a notebook personal computer.

Referring to FIG. 1, the information processing apparatus includes a computer main body 1 and a display unit (cover) 2. The display unit 2 is attached to the computer main body 1 such that it can move rotatably between an open position in which the top face of the computer main body 1 is exposed and a closed position in which the top face of the computer main body 1 is covered. The display unit 2 includes a display face (not shown) of a liquid crystal display (LCD) on its inside face and includes a solar battery panel of a solar battery 11 on its outside face.

The display unit 2 also includes an illumination sensor 12 at its upper end. The illumination sensor 12 is provided to control the luminance of the LCD in accordance with the ambient brightness. The information processing apparatus simplifies control for acquiring power from the solar battery 11 stably using the illumination sensor 12. This control simplification will be described below.

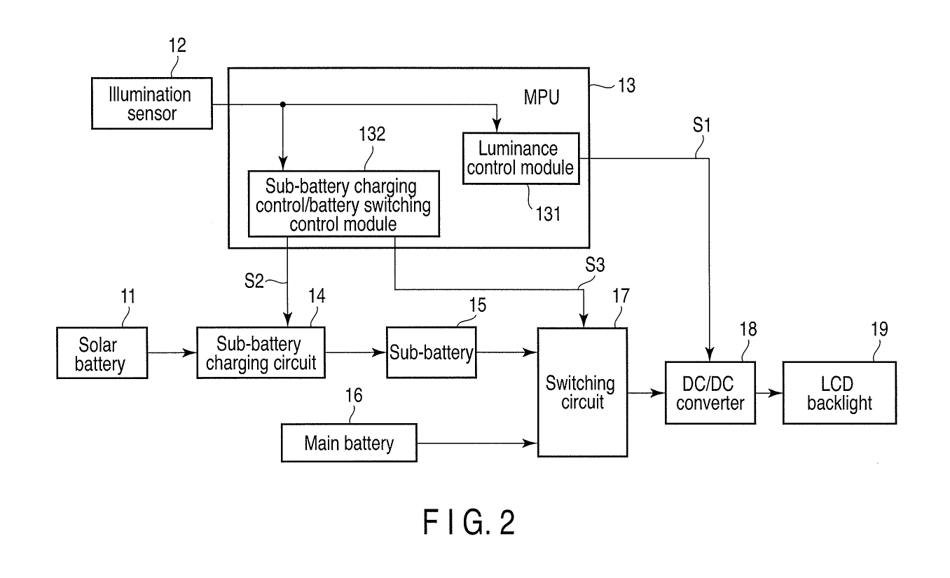

FIG. 2 is an exemplary block diagram partly showing a system configuration of the information processing apparatus. As illustrated in FIG. 2, the information processing apparatus includes the solar battery 11, the illumination sensor 12, a micro processing unit (MPU) 13, a sub-battery charging circuit 14, a sub-battery 15, a main battery 16, a switching circuit 17, a direct current/direct current (DC/DC) converter 18 and an LCD backlight 19.

The main battery 16 is a power supply which supplies power for operating the information processing apparatus. The solar battery 11 is not adequate to acquire power to such an extent that the main battery 16 can be charged; thus, the sub-battery 15, which has a small capacity, is provided. The sub-battery 15 is charged with power acquired from the solar battery 11, and the power stored in the sub-battery 15 is used for lighting the LCD backlight 19.

The sub-battery charging circuit 14 is a circuit which performs control for charging the sub-battery 15 with power acquired by the solar battery 11. The switching circuit 17 is a circuit which selects one of the sub-battery 15 and main battery 16 to supply power therefrom to light the LCD backlight 19. The DC/DC converter 18 is a circuit which controls the luminance of the LCD backlight 19. The MPU 13 controls the sub-battery charging circuit 14, switching circuit 17 and DC/DC converter 18 on the basis of a sensing result of the illumination sensor 12.

As described above, the illumination sensor 12 is provided to control the luminance of the LCD in accordance with the ambient brightness. To control the luminance of the LCD, the MPU 13 includes a luminance control module 131. In accordance with a sensing result of the illumination sensor 12, the luminance control module 131 controls the supply of a control signal S1 to the DC/DC converter 18 in order to control a voltage to be applied to the LCD backlight 19.

The MPU 13 also includes a sub-battery charging control/battery switching control module 132 in order not only to control the luminance of the LCD but also to charge the sub-battery 15 with the output voltage of the solar battery 11 and to select a power supply source from which power is applied to the LCD backlight 19 in accordance with the sensing result of the illumination sensor 12.

When luminance to be sensed by the illumination sensor 12 is equal to or lower than a predetermined value, the sub-battery charging control/battery switching control module 132 supplies a control signal S2 to the sub-battery charging circuit 14 to stop charging the sub-battery 15 with the output voltage of the solar battery 11, and supplies a control signal S3 to the switching circuit 17 to set the power supply source of the LCD backlight 19 to the sub-battery 15.

When luminance to be sensed by the illumination sensor 12 is higher than the predetermined value, the module 132 supplies the control signal S2 to the sub-battery charging circuit 14 to charge the sub-battery 15 with the output voltage of the solar battery 11, and supplies the control signal S3 to the switching circuit 17 to set the power supply source of the LCD backlight 19 to the main battery 16.

The MPU 13 recognizes a condition under which adequate sunlight can be received, as an opportunity to charge the sub-battery 15 which is a secondary battery that can be charged repeatedly to store power acquired from the solar battery 11. The MPU 13 also recognizes a condition under which no adequate sunlight can be received, as an opportunity to discharge the stored power from the sub-battery 15. In this way, the MPU 13 operates to receive the most of solar energy.

The luminance control module 131 of the MPU 13 controls the DC/DC converter 18 such that the LCD maintains its luminance at a luminance value preset by a user. If the luminance value of the LCD is set at not higher than a level at which the apparatus can be operated by power from the sub-battery 15, the switching circuit 17 is controlled to set the power supply source of the LCD backlight 19 to the sub-battery 15 (condition under which no adequate sunlight can be received).

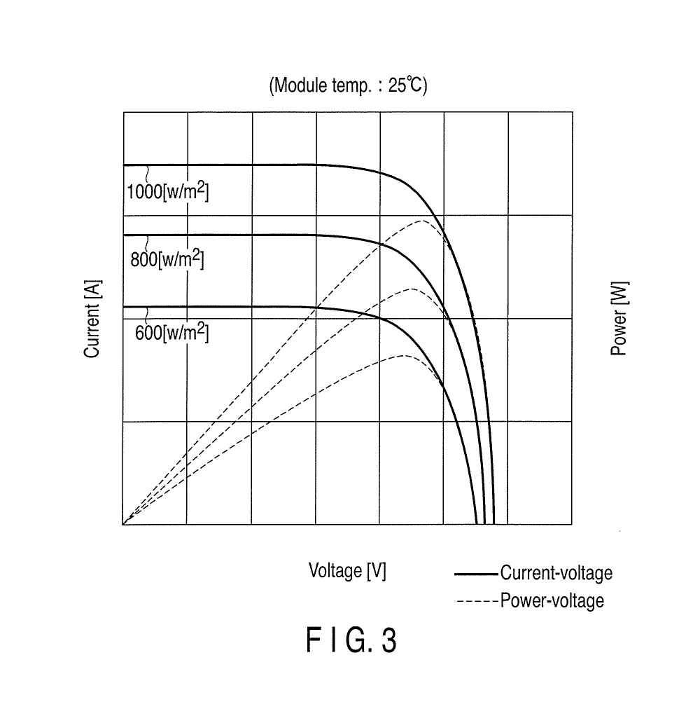

FIG. 3 is an exemplary graph showing an example of radiation intensity characteristic (voltage-to-current characteristic) of the solar battery 11.

Referring to FIG. 3, the no-load voltage (open-circuit voltage) does not vary so greatly with radiation intensity and, if a fixed amount of current is acquired from the solar battery 11, the output voltage varies greatly with radiation intensity. Radiation intensity that is equal to or higher than a given value is therefore required to acquire power stably from the solar battery 11. Conventionally, the output voltage and output current of a solar battery are frequently monitored. In the information processing apparatus of the embodiment, the illumination sensor 12 (which is provided to control the luminance of the LCD in accordance with the ambient brightness) is employed to check whether radiation intensity that is equal to or higher than a given value is obtained, thereby simplifying the operation algorithm of the sub-battery charging control/battery switching control module 132 and thus decreasing in cost.

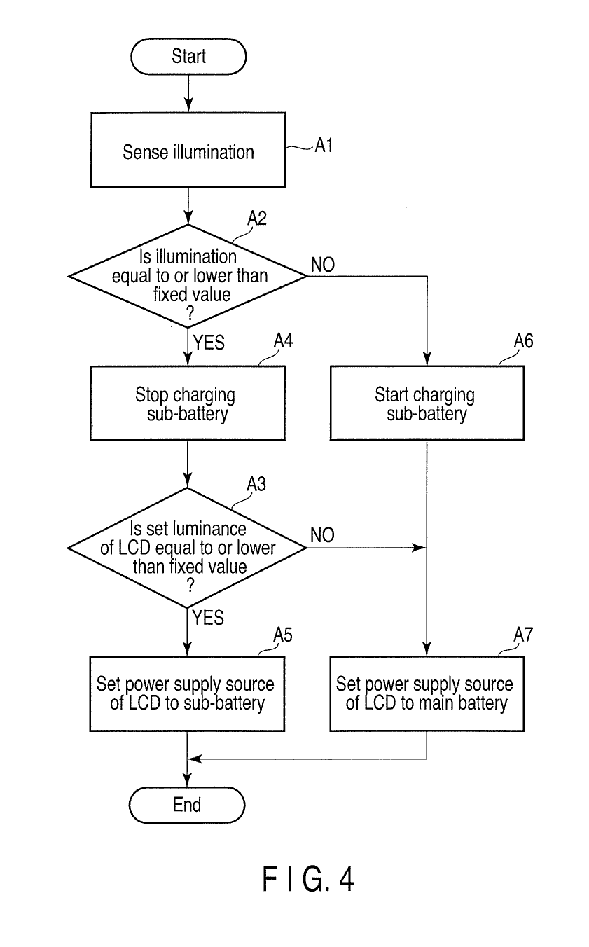

FIG. 4 is an exemplary flowchart showing a control procedure of the solar battery 11 based on the sensing result of the illumination sensor 12 of the information processing apparatus.

The MPU 13 detects ambient illumination of the information processing apparatus using the illumination sensor 12 (block A1) and checks whether or not the detected illumination is equal to or lower than a fixed value (block A2). If the illumination is equal to or lower than the fixed value (YES in block A2), the MPU 13 controls the sub-battery charging circuit 14 to stop charging the sub-battery 15 with the output voltage of the solar battery 11 (block A4).

The MPU 13 then checks whether or not the set luminance of the LCD is equal to or lower than a fixed value (block A3). If the set luminance is equal to or lower than the fixed value (YES in block A3), the MPU 13 controls the switching circuit 17 to set the power supply source of the LCD backlight 19 to the sub-battery 15 (block A5). If the set luminance of the LCD is higher than the fixed value (NO in block A3), the MPU 13 controls the switching circuit 17 to set the power supply source of the LCD backlight 19 to the main battery 16 (block A7).

If the detected ambient illumination of the apparatus is higher than the fixed value (NO in block A2), the MPU 13 controls the sub-battery charging circuit 14 to charge the sub-battery 15 with the output voltage of the solar battery 11 (block A6) and controls the switching circuit 17 to set the power supply source of the LCD backlight 19 to the main battery 16 (block A7).

As described above, the information processing apparatus of the embodiment allows simplification of control to acquire power stably from the solar battery.

In this embodiment, the illumination sensor 12, which is provided to control the luminance of the LCD in accordance with the ambient brightness of the solar battery, is employed to control associated with the solar battery 11. The information processing apparatus is not limited to this. For example, if the illumination sensor 12 is absent, another illumination sensor for control associated with the solar battery 11 can be provided.

In this embodiment, the output voltage of the solar battery 11, which is stored in the sub-battery 15, is used to light the LCD backlight 19. The information processing apparatus is not limited to this. For example, it can be used to emit light from the LED provided for notifying a use of status of the information processing apparatus.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first battery;
a second battery whose capacity is smaller than capacity of the first battery;
a solar battery;
a charging circuit configured to charge the second battery with power output from the solar battery;
an illumination sensor; and
a controller configured to control the charging circuit in accordance with a sensing result of the illumination sensor.

2. The apparatus of claim 1, wherein the controller is configured to control the charging circuit to stop charging the second battery with power output from the solar battery when a value of illumination intensity sensed by the illumination sensor is equal to or lower than a predetermined value.

3. The apparatus of claim 2, further comprising:
a liquid crystal display comprising a backlight; and
a switching circuit configured to select one of the first battery and the second battery to apply power therefrom to the liquid crystal display for lighting the backlight,
wherein the controller is configured to control the switching circuit to apply the power from the second battery to the liquid crystal display when the value of illumination intensity sensed by the illumination sensor is equal to or lower than the predetermined value.

4. The apparatus of claim 3, wherein the controller is configured to control the switching circuit to apply the power from the second battery to the liquid crystal display when a value of set luminance of the liquid crystal display is equal to or lower than a predetermined value.

5. The apparatus of claim 3, further comprising:
a body; and
a cover attached to the body to move rotatably between an open position in which a top face of the body is exposed and a closed position in which the top face of the body is covered,
wherein:
the liquid display is arranged on an inside face of the cover, which is hidden when the cover is positioned at the closed position;
the solar battery comprises a sunlight panel that is arranged on an outside face of the cover, which is exposed when the cover is positioned at the closed position; and
the illumination sensor is arranged at a top end of the cover.

6. The apparatus of claim 2, further comprising:
a light emitting diode; and
a switching circuit configured to select one of the first battery and the second battery to apply power therefrom to the light emitting diode for emitting light from the light emitting diode,
wherein the controller is configured to control the switching circuit to apply the power from the second battery to the light emitting diode when the value of illumination intensity sensed by the illumination sensor is equal to or lower than the predetermined value.

7. An information processing apparatus comprising:
a first battery;
a second battery whose capacity is smaller than capacity of the first battery;
a solar battery;
a charging circuit configured to charge the second battery with power output from the solar battery;
an illumination sensor;
a liquid crystal display comprising a backlight;
a switching circuit configured to select one of the first battery and the second battery to apply power therefrom to the liquid crystal display for lighting the backlight; and
a controller configured to control the switching circuit in accordance with a sensing result of the illumination sensor.

8. The apparatus of claim 7, wherein the controller is configured to control the switching circuit to apply the power from the second battery to the liquid crystal display when the value of illumination intensity sensed by the illumination sensor is equal to or lower than a predetermined value.

9. The apparatus of claim 8, wherein the controller is configured to control the switching circuit to apply the power from the second battery to the liquid crystal display when a value of set luminance of the liquid crystal display is equal to or lower than a predetermined value.

10. A method for controlling charging of a battery in a battery-driven information processing apparatus comprising a solar battery and an illumination sensor, comprising:
sensing illumination intensity using the illumination sensor; and
controlling charging of the battery with power output from the solar battery in accordance with the sensed illumination intensity.

11. The method of claim 10, further comprising stopping to charge the battery with the power output from the solar battery when a value of the sensed illumination intensity is equal to or lower than a predetermined value.
